(19) United States
(12) Patent Application Publication
(10) Pub. No.: US 2002/0050130 A1
(43) Pub. Date: May 2, 2002

(54) TOOLS FOR FOLDING SHEET-LIKE BLANKS AROUND BLOCK-SHAPED COMMODITIES IN WRAPPING MACHINES

(76) Inventor: JURGEN GROSSMANN, WENTORF (DE)

Correspondence Address: VENABLE, PO BOX 34385, WASHINGTON, DC, 200439998

(21) Appl. No.: 09/333,928

(22) Filed: Jun. 16, 1999

(30) Foreign Application Priority Data
Jun. 16, 1998 (DE) 198 26 663.4

(51) Int. Cl. B65G 11/06

(52) U.S. Cl. 53/574

(57) ABSTRACT

A male or female tool in a wrapping machine for confinement of preferably or normally cuboid commodities in deformable sheet-like blanks of metallic foil or the like has at least one reciprocable, indexible and/or otherwise movable base portion or carrier of a lightweight material (e.g., a low-density fiber-reinforced thermoplastic material), and one or more wear-resistant liners overlying that surface or those surfaces of the carrier which participates or participate in deformation of a blank around the respective commodity. The liner can but need not be a laminate and can contain or consist of hardened steel, a ceramic material and/or others. Such liner can be bonded and/or mechanically affixed to the relevant surface or surfaces of the carrier.

### BACKGROUND OF THE INVENTION

The present invention relates to improvements in apparatus for wrapping or draping deformable sheet-like blanks around block-shaped commodities, and more particularly to improvements in devices, implements or tools (hereinafter called tools for short) which are utilized in such apparatus to directly or indirectly contact and deform the blanks (e.g., sheets or panels made of paper, metallic or plastic foil, cardboard or the like) for the purpose of causing the blanks to conform to the outlines of block-shaped commodities. Typical examples of such tools are stationary or mobile male and/or female tools which are utilized in cigarette packing machines to confine block-shaped (such as cuboid) arrays of plain or filter cigarettes (such arrays can but need not always be confined in inner envelopes of metallic foil or the like) in outer envelopes constituting so-called hinge lid packets or other types of containers for cigarettes.

A variety of tools for active or passive draping of deformable sheet-like or panel-like blanks around arrays of cigarettes or the like are in extensive use in various types of cigarette packing and related machines. The purpose of such tools is to convert sheet-like blanks into a plurality of coherent sections in the form of walls, panels, flaps, tucks or the like and to provide sharply out-lined or rounded (e.g., bevelled) fold lines or zones between selected or all sections. Examples of so-called active tools are mobile tools in the form of rotary, reciprocable or otherwise displaceable tools. On the other hand, a passive tool can serve as a profiled stationary back support or part which can define one or more pockets for reception of blanks which are deformed against the profiled passive tool in response to advancement of a commodity into the pocket, e.g., in response to displacement of the commodity by an active tool. An example of a passive tool is a turret or turntable which is indexible about a vertical or horizontal axis and has at least one pocket for reception of blanks from a suitable source prior to deformation of such blanks by block-shaped commodities which are forced into the pockets with a force that is necessary to deform the blanks against the surfaces bounding the respective pockets.

Apparatus and machines which utilize active and passive, male and/or female tools constructed and assembled in accordance with the present invention are disclosed, for example, in U.S. Pat. No. 5,653,086 (granted Aug. 5, 1997 to Spada et al. for “PACKAGING MACHINE FOR DELICATE ROD-SHAPED OBJECTS, ESPECIALLY CIGARETTES OR THE LIKE”; in U.S. Pat. No. 4,730,442 (granted Mar. 15, 1988 to Focke et al. for “APPARATUS FOR PRODUCING PACKS WITH BEVELLED OR ROUNDED LONGITUDINAL EDGES”); in U.S. Pat. No. 4,843,798 (granted Jul. 4, 1989 to Focke et al. for “PROCESS AND APPARATUS FOR PRODUCING PACKS WITH BEVELLED OR ROUNDED LONGITUDINAL EDGES”); in German Utility Model No. DE 296 05 419 US (assigned to Topack Verpackungstechnik GmbH, published Jul. 11, 1996 and titled “RECEIVING POCKET OF A CHAMBERED BAND FOR THE TRANSPORT OF BLOCKS OF ROD-SHAPED ARTICLES”); and in German patent No. DE 44 36 717 C1 (granted Apr. 4, 1996 to Manfred Oberdorf for “CONVEYOR FOR CONDENSING OF CIGARETTE BLOCKS”).

A drawback of presently known tools, for example, of the type disclosed in the just enumerated prior publications, is that their useful life is rather short. The reason is that, when used in a high-speed wrapping apparatus (e.g., in a cigarette packing machine), at least the active (mobile) tools undergo repeated acceleration and deceleration at a very high frequency so that the wear upon such tools, as well as upon the passive tools which directly or indirectly cooperate with the active tools, is very pronounced. This necessitates frequent stoppages of the wrapping apparatus, of the entire cigarette packing machine, or even the entire production line which employs one or more wrapping apparatus utilizing active and/or passive blank-deforming tools. Furthermore, once the tools have undergone a certain amount of wear, the wrapping apparatus is likely or bound to turn out unsatisfactory envelopes (converted blanks) which detract from the appearance and sales appeal of the ultimate products, such as packets of hinge lid cigarettes.

### OBJECTS OF THE INVENTION

An object of the invention is to provide a tool which is constructed and assembled in such a way that its life expectancy greatly exceeds that of presently known tools which are utilized in apparatus for draping sheet-like blanks around block-shaped commodities.

Another object of the invention is to enhance the mobility of active tools in wrapping or draping apparatus of the above out-lined character.

A further object of the invention is to provide relatively inexpensive tools for use in apparatus for draping or wrapping sheet-like blanks around block-shaped commodities.

An additional object of the invention is to provide novel and improved combinations of materials for the making of the above out-lined improved tools.

Still another object of the invention is to provide a novel wrapping apparatus embodying one or more tools which are constructed and assembled in accordance with my invention.

A further object of the invention is to provide a novel and improved apparatus for wrapping sheet-like blanks about block-shaped arrays of plain or filter cigarettes or other smokers' products.

Another object of the invention is to provide a novel and improved indexible, pivotable, reciprocable and/or otherwise movable tool for use in high-output wrapping or packing apparatus and machines.

An additional object of the invention is to provide a novel and improved method of making active or passive tools of the above out-lined character for use in wrapping apparatus.

### SUMMARY OF THE INVENTION

The invention is embodied in a tool which is to be utilized (or which can be utilized) for conversion of deformable sheet-like blanks (e.g., blanks made of metallic foil, paper, cardboard or the like) into envelopes (e.g., into so-called hinged lid packets) for block-shaped commodities (e.g., for at least substantially cuboid commodities such as customary arrays of plain or filter cigarettes, e.g., twenty cigarettes in the so-called quincunx formation). The improved tool comprises at least one lightweight base component, core or carrier (hereinafter called carrier) having at least one blank-deforming surface (e.g., a flat surface), and at least one wear-resistant coat, film or liner (hereinafter called liner) which overlies at least the at least one blank-deforming surface.

The carrier can contain (or can be made of) a low-density material having a relatively high modulus of elasticity; for example, the carrier can be made of a fiber-reinforced thermoplastic material. Suitable thermoplastic materials are (among others) those known as PEEK BG, PEEK CF30 and PA 66 CF20.

The at least one liner can consist, at least in part, of hardened steel and/or of a suitable ceramic material. Such liner can be bonded (e.g., by means of a suitable adhesive) and/or mechanically affixed to the at least one carrier and can have a thickness of less than one millimeter. Amorphous carbon is one of the presently preferred materials for the making of the at least one liner.

It is also possible to employ a liner which is a laminate including a first layer or lamina which is affixed to the at least one carrier, and a second layer or lamina which overlies the first layer and comes into direct contact with the blanks. The second layer can contain or it can consist of amorphous carbon, and the first layer can consist of spring steel; such first layer can have a thickness of approximately 0.3 millimeter. The first layer can be bonded (e.g., by resorting to a suitable adhesive) to the at least one carrier or it can be mechanically affixed to the carrier; for example, the at least one surface of the at least one carrier and the first layer of the laminate can be provided with mating teeth in the form of serrations or the like.

The tool can be a male tool or a female tool. For example, the at least one carrier can define at least one pocket for blanks and commodities and can be provided with several surfaces bounding the at least one pocket. The at least one liner can include several portions each of which overlies at least one of the several surfaces. At least one portion of the just mentioned at least one liner can be configurated to impart at least one fold line to a portion of the blank which occupies the at least one pocket.

The at least one carrier can be installed in a wrapping machine for angular movement about a vertical, horizontal or otherwise inclined axis.

The novel features which are considered as characteristic of the invention are set forth in particular in the appended claims. The improved tool itself, however, both as to its construction and the modes of making and utilizing the same, together with numerous additional important and advantageous features and attributes thereof, will be best understood upon perusal of the following detailed description of certain presently preferred specific embodiments with reference to the accompanying drawings.

### BRIEF DESCRIPTION OF THE DRAWINGS

FIG. 1 is a fragmentary schematic partly elevational and partly sectional view of a wrapping apparatus which can be utilized in a cigarette packing machine and comprises several tools which are or which can be constructed and assembled in accordance with one embodiment of the instant invention;

FIG. 2 is a side elevational view of a folding tool in the apparatus of FIG. 1;

FIG. 3 is a view as seen in the direction of arrow A in FIG. 2;

FIG. 4 is a sectional view substantially as seen in the direction of arrows from the line B-C of FIG. 2;

FIG. 5 is a plan view of a female tool which can be utilized in the apparatus of FIG. 1 and is provided with a pocket for block-shaped arrays of plain or filter cigarettes or other smokers' products and for blanks which are to be draped around such arrays;

FIG. 6 is a sectional view substantially as seen in the direction of arrows from the line D-E of FIG. 5;

FIG. 7 is a side elevational view of an indexible tool which is provided with an annulus of radially extending pockets for sheet-like blanks and block-shaped commodities;

FIG. 8 is a sectional view substantially as seen in the direction of arrows from the line F-G in FIG. 7; and

FIG. 9 is a plan view substantially as seen in the direction of arrow Z in FIG. 7.

### DESCRIPTION OF PREFERRED EMBODIMENTS

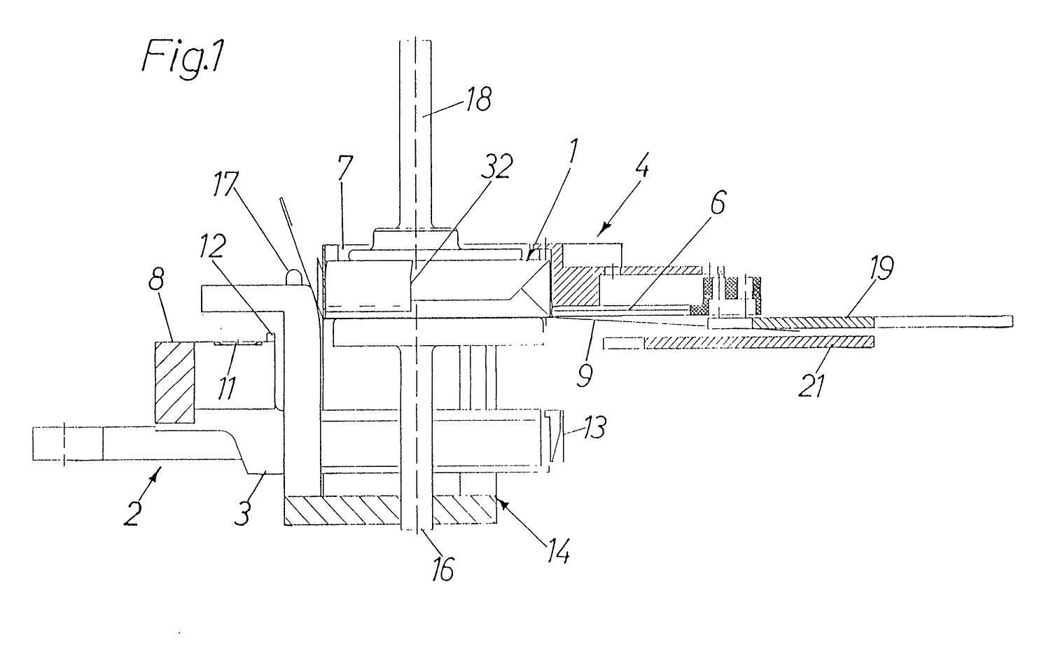

FIG. 1 shows a portion od an apparatus for wrapping sheet- or panel-like blanks 9 around block-shaped (cuboid) commodities 1. Each such commodity is assumed to consist of an array of twenty plain or filter cigarettes in the so-called quincunx formation, and an inner envelope of paper, metallic foil or plastic foil which is draped around a portion of or around the entire array. The blank 9 can be made of cardboard, paperboard or the like, and the apparatus including the structure of FIG. 1 can be designed to convert the blank 1 into a hinge lid packet or another receptacle for the commodity 1.

The apparatus comprises a first or lower conveyor 2 in the form of a turntable which is rotatable (indexible) about a vertical axis and is provided with several pockets 3 (only one shown in FIG. 1). The turntable 2 cooperates with a second or upper conveyor 4 constituting or including an indexible turntable which partially overlies the turntable 2. The turntable 4 comprises pockets 7, which have open undersides adapted to be closed by reciprocable lids 6, and is indexible about a vertical axis.

The lower turntable 2 carries discrete platforms 8, one for each pocket 3 and each adapted to receive and support from below a discrete blank 9 so that the latter overlies the open upper side of the respective pocket 3. The platforms 8 are provided with suction ports 11 which are connected or connectable with a suitable suction generating device (not shown) whenever the platform is called upon to attract a blank 9. Each plaform 8 is further provided with strip-shaped raised portions 12. Holders 13 of the lower turntable 2 flank the pockets 3.

The parts which are shown in FIG. 1 together define a folding or wrapping station, and such parts further comprise a lower or inner pusher or bottom support 16 which can prop a commodity 1 from below and is associated with the lower turntable 2, and a vertically reciprocable outer folding pusher 14. The pushers 14, 16 can move with or relative to each other, namely the pusher 14 is movable across the plane of the platform 8 and the pusher 16 is movable through the then aligned pocket 3. The pusher 14 is provided with protuberances 17.

The upper pusher 18 can move in synchronism with or downwardly relative to the lower pusher 16. Still further, the parts of the folding station of FIG. 1 include auxiliary guides 19, 21 for the blanks 9; the guides 19, 21 are located above and are slightly spaced apart from each other and are movable in synchronism with the pushers 14, 16.

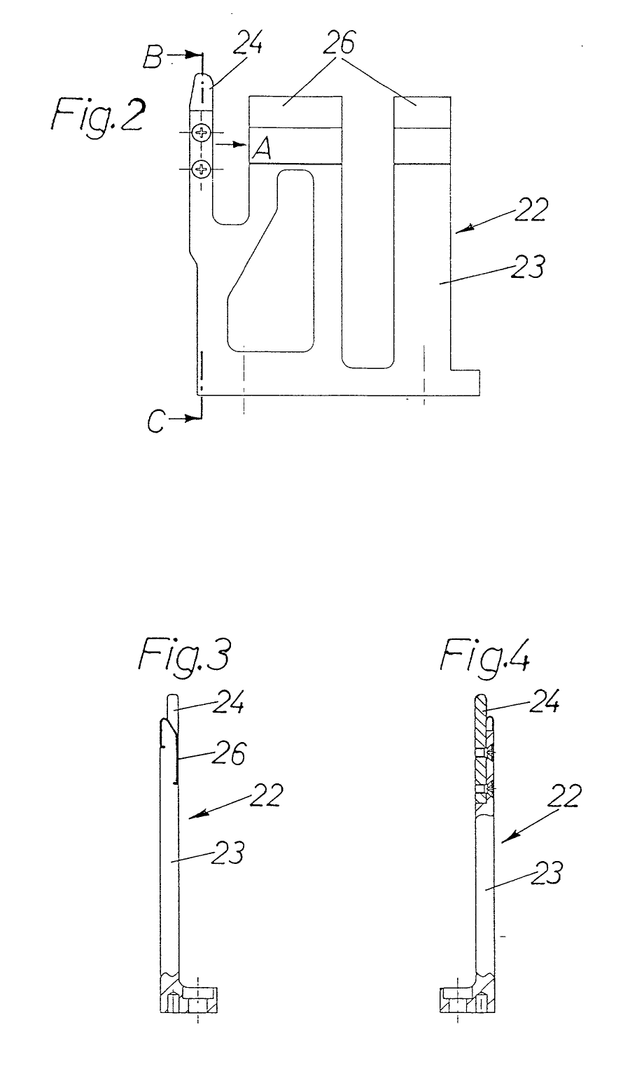

FIGS. 2, 3 and 4 illustrate certain details of a folding tool 22 which forms part of the aforementioned pusher 14 and is constructed in accordance with one embodiment of the present invention. The tool 22 comprises a base portion or carrier 23 of a relatively lightweight material having a relatively high modulus of elasticity and a low density. For example, the carrier 23 can be made of a filament- or fiber-reinforced thermoplastic material. Those surfaces of the carrier 23 which participate in the draping of a blank 9 around the adjacent commodity 1 are coated or shielded by a relatively or extremely thin liner 24 of a highly wear-resistant material. For example, the liner 24 can be bonded (such as by means of a suitable adhesive) to the active surfaces of the carrier 23. Alternatively, the liner 24 can be affixed to the carrier 23 by means of screws and/or by means of other suitable threaded and/or unthreaded fasteners. For example, the liner 24 can be made of hardened steel. Alternatively, or in addition to a liner 24, two highly wear-resistant liners 26 shown in FIG. 2 (e.g., thin plates made of spring steel) can be provided with teeth or ribs in the form of claws, serrations or the like (see FIGS. 2 and 3) and can be bonded to the aforementioned active surface or surfaces of the carrier 23 forming part of the folding tool 22.

The exact mode of operation of the wrapping apparatus including the structure shown in FIG. 1 is known in the art. Briefly stated, when the turntables 2, 4 are at a standstill, the pocket 7 which is then located at the wrapping station of FIG. 1 receives a commodity 1 and the guides 19, 21 steer an undeformed blank 9 to a requisite position beneath the commodity. The pushers 14, 16, 18 then cooperate to at least partially drape the blank 9 around the commodity 1 in the pcket 7, on the way from the pocket 7 into the pocket 3, and/or in the pocket 3.

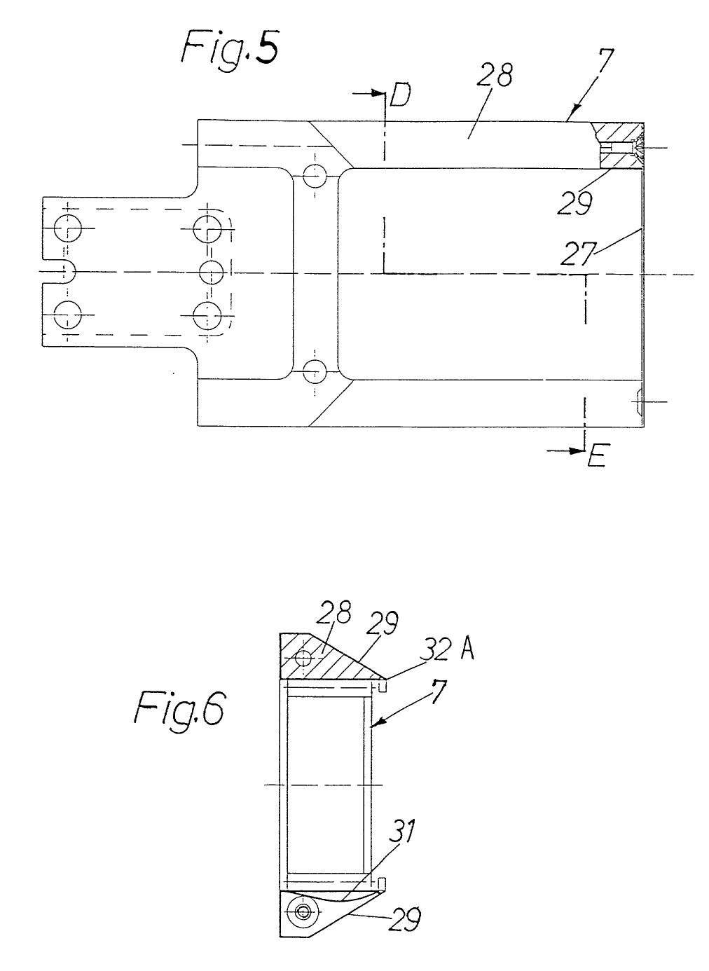

FIGS. 5 and 6 illustrate a second tool which can constitute the entire upper turntable 4 or that portion of this turntable which defines at least one of the pockets 7. The front end portion of this tool comprises a lightweight carrier 28 for a highly wear-resistant liner 27 and for a wear-resistant jacket or liner 29; for example, such liners can be made of a relatively thin sheet steel stock having a thickness of less than one millimeter, e.g., about 0.3 millimeter. The liners 27 and 29 come into direct deforming (such as bevelling, folding and/or other) contact with selected portions of a blank 9 which is to be draped around a portion of the carrier 28.

The front portion of the tool of FIGS. 5 and 6 is provided with a recess or depression 31 for reception of a so-called collar 32 (refer to FIG. 1) which forms part of the block-shaped commodity 1. The jacket 29 provides a pronounced (sharp) edge 32A for the lateral flaps of a blank 9; such flaps are caused to lie against the lateral walls bounding the pocket 7.

When the tool forming part of or constituting the turntable 4 and the tool 22 are in actual use, the lightweight carrier 23 of the folding pusher 14 and the lightweight carrier of the turntable undergo highly pronounced alternating accelerations and decelerations. FIG. 1 shows the turntable 4 in a position of rest between two rapidly following successive indexing movements each of which involves a rapid acceleration followed by a rapid deceleration of such turntable. The various folding or wrapping tools are in the process of simultaneously folding front and lateral panels, walls, tucks and/or flaps against the adjacent portions of the commodity 1 at the wrapping or folding station. The just mentioned panels, walls, tucks and/or flaps are contacted only by the liners (such as 24, 26, 27, 29) but not by the soft carriers or cores or bases (such as 23 and 28) of the respective tools. The pusher 16 thereupon cooperates with the pusher 18 to transfer the partly deformed blank 9 and the partly wrapped commodity 1 into the pocket 3 of the turret 2.

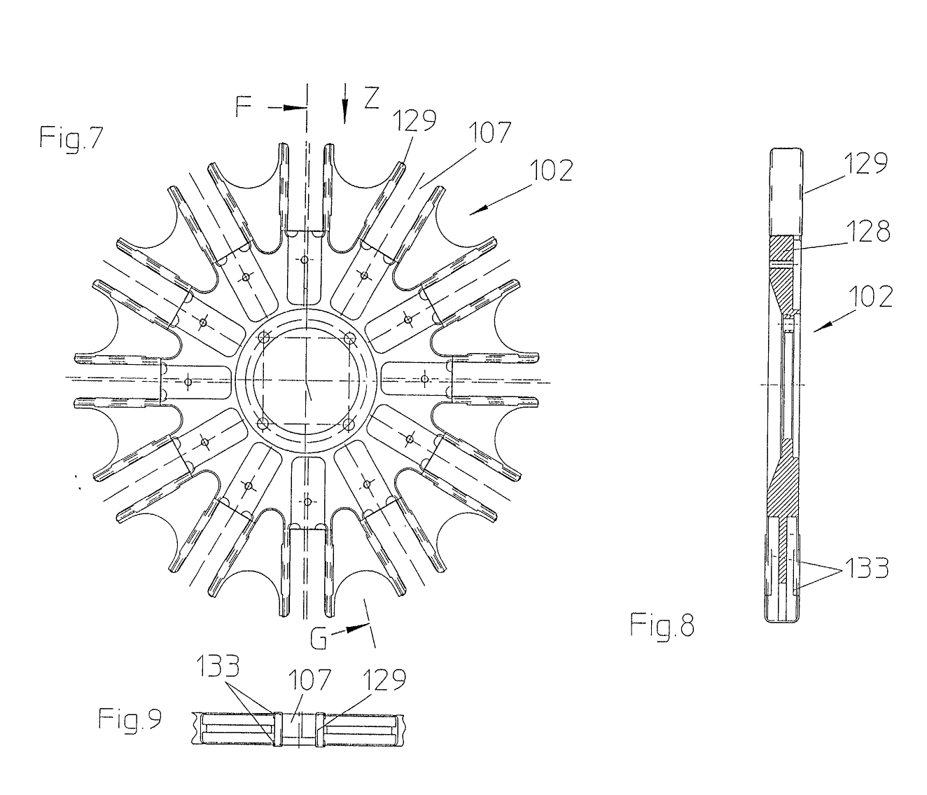

FIGS. 7, 8 and 9 illustrate a tool 102 in the form of a turret which is indexible about a horizontal axis and is provided with an annulus of equidistant radially extending pockets 107 having open radially outer ends. This tool forms part of a modfified wrapping apparatus and includes a lightweight carrier 128. At least those surfaces of the carrier 128 which are adjacent the pockets 107 are provided with liners 129, made of a suitable wear-resistant material, which come in direct contact with blanks to be converted into envelopes surrounding discrete block-shaped commodities. The means for securing the liner or liners 129 to the carrier 128 comprises suitable clamps 133. It is clear that such clamps can be utilized jointly with or that they can be replaced by other suitable means for securing the liner or liners 129 to the carrier or carriers 128.

The tools of the present invention can assume many other shapes (e.g., in the form of pushers, flaps, levers and/or others) without departing from the spirit of the present invention. An advantage of such tools is their longevity, even if they are put to use under adverse circumstances involving high-frequency accelerations and decelerations as well as repeated flexing and analogous treatments of relatively stiff blanks.

As already mentioned hereinbefore, the carrier or carriers of the improved tool can consist of a low-density material having a relatively high modulus of elasticity. Presently preferred examples of such materials are thermoplastic substances which are reinforced by filaments, such as glass fibers or the like. The thermoplastic substances which have been found to be highly satisfactory for the making of carriers for use in the improved blank-converting tools are those known in the relevant industry as PEEK BG, PEEK CF30 and PA 66 CF 20.

The selection of the material for the making of the liner or liners will depend, at least to a certain extent, upon the intended use of the improved tools. It is often advisable to select a liner which is resistant to wear in that it is made of hardened steel and/or a ceramic material; such liner can be bonded or mechanically affixed (e.g., screwed and/or riveted) to one or more selected surfaces of the carrier. If the liner is a laminate, it can comprise at least two layers or laminates, e.g., an inner layer of spring steel having a thickness of about 0.3 millimeter and an outer layer of amorphous carbon (PCVD). The spring steel can be of the type known as X12CrNi17.7. Steel sheet stock is one presently preferred material for the making of non-laminated liners as well as for the making of laminated liners which, in addition to a steel layer, contain at least one additional layer.

Without further analysis, the foregoing will so fully reveal the gist of the present invention that others can, by applying current knowledge, readily adapt it for various applications without omitting features that, from the standpoint of prior art, fairly constitute essential characteristics of the generic and specific aspects of the above out-lined contribution to the art of tools for folding sheet-like blanks around block-shaped commodities in wrapping machines and, therefore, such adaptations should and are intended to be comprehended within the meaning and range of equivalence of he appended claims.

What is claimed is:

1. A tool for conversion of deformable sheet-like blanks into envelopes for block-shaped commodities, comprising at least one lightweight carrier having at least one blank-deforming surface; and at least one wear-resistant liner overlying at least said at least one blank-deforming surface.

2. The tool of claim 1, wherein said at least one wear-resistant liner is configurated to deform blanks arranged to constitute envelopes for at least substantially cuboid commodities.

3. The tool of claim 1, wherein said carrier contains a low-density material having a relatively high modulus of elasticity.

4. The tool of claim 3, wherein said material is a fiber-reinforced thermoplastic material.

5. The tool of claim 1, wherein at least a portion of said carrier consists of a material selected from the group consisting of PEEK BG, PEEK CF30 and PA 66 CF20.

6. The tool of claim 1, wherein said at least one liner consists at least in part of hardened steel.

7. The tool of claim 1, wherein said at least one liner consists at least in part of a ceramic material.

8. The tool of claim 1, wherein said at least one liner is bonded to said at least one carrier.

9. The tool of claim 1, wherein said at least one liner has a thickness of less than one millimeter.

10. The tool of claim 1, wherein said at least one liner consists at least in part of amorphous carbon.

11. The tool of claim 1, wherein said at least one liner is a laminate including a first layer which is affixed to said at least one carrier and a second layer overlying said first layer and arranged to contact the blanks.

12. The tool of claim 11, wherein said second layer consists of amorphous carbon.

13. The tool of claim 11, wherein said first layer consists of spring steel.

14. The tool of claim 13, wherein said first layer has a thickness of approximately 0.3 millimeter.

15. The tool of claim 11, wherein said first layer of said laminate is bonded to said at least one carrier.

16. The tool of claim 11, wherein said first layer and said at least one surface have mating teeth.

17. The tool of claim 11, wherein said at least one carrier and said laminate form part of a mobile sheet-folding pusher.

18. The tool of claim 1, wherein said at least one carrier defines at least one pocket for blanks and commodities and has several surfaces bounding said at least one pocket, said at least one liner including several portions each overlying at least one of said several surfaces.

19. The tool of claim 18, wherein at least one portion of said at least one liner is configurated to impart a fold line to a portion of a blank occupying said at least one pocket.

20. The tool of claim 1, wherein said at least one carrier is turnable about a predetermined axis.
